(19) United States
(12) Patent Application Publication
(10) Pub. No.: US 2003/0045329 A1
(43) Pub. Date: Mar. 6, 2003

(54) Mobile terminal device and method for recording and processing telephone call

(75) Inventor: Masashi Kinoshita, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/225,289

(22) Filed: Aug. 22, 2002

(30) Foreign Application Priority Data
Aug. 29, 2001 (JP) 259759/2001

(51) Int. Cl. H04M 1/00

(52) U.S. Cl. 455/563; 455/566; 455/414

(57) ABSTRACT

A mobile terminal device comprises a voice recognition processing unit and semiconductor memory that has a plurality of areas. During a telephone call, a user can operate input means to perform voice recognition of any portions of the telephone call and store the conversation as strings in the memory areas. After the telephone call is completed, the user can cause the strings stored in the memory areas to be displayed, and edit and send them by e-mail. It is possible to display only those strings in the areas that contain information required by the user.

### BACKGROUND OF THE INVENTION

1. Field of the Invention

This invention relates to a method and a mobile terminal device for performing voice recognition, recording, and editing of a telephone call conversation in the mobile terminal device.

2. Description of the Related Prior Art

Voice recognition technology is used in various technical fields. In the field of telephones, for example, a telephone is known that has functions of performing voice recognition of a telephone call conversation and transforming it into text data. For example, in a telephone terminal device disclosed in Japanese Patent Laid-Open No. 2000-216910, a voice recognition unit recognizes a voice of a telephone call. A caller identification unit identifies a caller of the telephone call, and a text data transformation unit transforms the result of the voice recognition into text data. A text editing unit edits the text data, which is sent by e-mail or facsimile.

However, this telephone terminal device continuously performs voice recognition throughout a telephone call. Therefore, the text data will contain unnecessary or unimportant portions of a conversation. Once the amount of text data reaches the capacity of memory in the device, further text data cannot be stored. Moreover, editing long text data is lengthy and cumbersome.

### SUMMARY OF THE INVENTION

Thus, an object of the invention is to provide a method and a mobile terminal device that has a voice recognition function, wherein the method and the device achieve efficient editing of information of strings resulting from voice recognition.

A method for recording a telephone call according to the invention comprises the steps of: (a) starting voice recognition of a telephone call conversation during the telephone call; (b) transforming the conversation subjected to voice recognition into strings and storing the strings in memory of the mobile terminal device; and (c) stopping voice recognition of the conversation during the telephone call.

The method may further comprise the steps of: (d) displaying the stored strings on a display unit after the telephone call is completed; and (e) editing the displayed strings on the display unit.

A method for processing a telephone call according to the invention comprises the steps of: (a) starting voice recognition of a telephone call conversation during the telephone call; (b) transforming the conversation subjected to voice recognition into strings and storing the strings in memory of the mobile terminal device; (c) stopping voice recognition of the conversation during the telephone call; (d) starting an e-mail application after the telephone call is completed; (e) displaying the stored strings on a display unit; (f) editing the displayed strings on the display unit; and (g) transmitting the edited strings by e-mail.

In one embodiment of the above described methods of the invention, a process from starting to stopping voice recognition may be performed for a plurality of times during one telephone call. In another embodiment, the strings resulting from each process from starting to stopping voice recognition may be stored in a separate area in the memory for each process. In still another embodiment, voice recognition may be performed for only a caller's part of the conversation. In still another embodiment, voice recognition of the conversation may be automatically started upon start of the telephone call. In still another embodiment, voice recognition of the conversation may be automatically stopped upon completion of the telephone call.

A mobile terminal device according to the invention comprises:

a telephone call receiver;

a voice recognition processing unit for performing voice recognition of a telephone call conversation and transforming the conversation into strings;

memory for storing the strings;

a telephone call storage controller for controlling voice recognition of the conversation and storage of the strings;

a voice recognition starting means;

a voice recognition stopping means;

a display unit for displaying the strings; and

a display controller for editing the strings on the display unit.

In one embodiment of the above described invention, the mobile terminal device may comprise a transmitter for transmitting the strings on the display unit. In another embodiment, the telephone call, storage controller may control the voice recognition processing unit so that voice recognition is performed for only a caller's part of the conversation. In still another embodiment, the memory may include a plurality of areas for storing the strings. In still another embodiment, the telephone call storage controller may control the voice recognition processing unit so that voice recognition is automatically started upon start of the telephone call. In still another embodiment, the telephone call storage controller may control the voice recognition processing unit so that voice recognition is automatically stopped upon completion of the telephone call. The capacity of each area of the memory may be variable, and the memory may be semiconductor memory. The voice recognition starting means and the voice recognition starting means may be combined into one switch.

Another mobile terminal device according to the invention comprises:

a telephone call receiver;

a voice recognition processing unit for performing voice recognition of a telephone call conversation and transforming the conversation into strings;

memory that includes a plurality of areas, each of which having a variable capacity;

a telephone call storage controller for controlling voice recognition of the conversation and storage of the strings;

a voice recognition starting means;

a voice recognition stopping means;

a display unit for displaying the strings;

a display controller for editing the strings on the display unit; and

a transmitter for transmitting the strings on the display unit.

These methods and devices can facilitate editing of strings resulting from voice recognition in the mobile terminal devices.

### BRIEF DESCRIPTION OF THE DRAWINGS

The above and other objects, features and advantages of the present invention will become apparent from the following detailed description when taken with the accompanying drawings in which:

FIG. 1 is a block diagram of a mobile terminal device according to an embodiment of the invention;

FIG. 2 is a flowchart of a method for transmitting e-mail according to the invention;

FIG. 3 is a block diagram showing a telephone call conversation and a caller's part of the conversation in memory resulting from voice recognition;

FIG. 4 is a block diagram showing the telephone call conversation and portions of the conversation in the memory resulting from voice recognition; and

FIG. 5 is a block diagram showing a process of editing the conversation resulting from voice recognition.

### DETAILED DESCRIPTION OF THE PREFERRED EMBODIMENTS

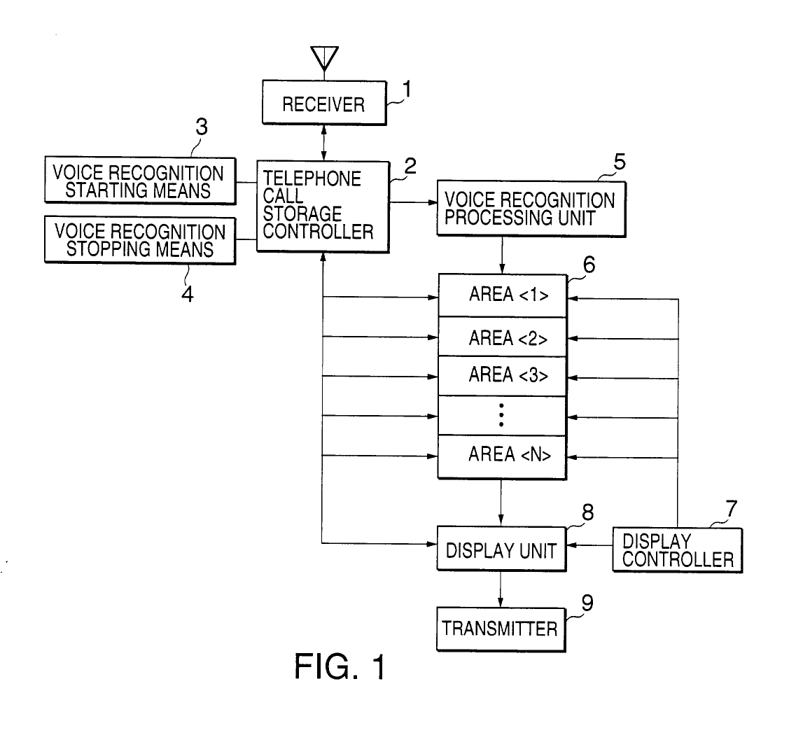

FIG. 1 shows an example of a mobile terminal device of the invention. The mobile terminal device may be configured based on GMS (Global System for Mobile Communication), for example. The mobile terminal device has a receiver 1 for receiving telephone calls, and a telephone call storage controller 2 for controlling voice recognition and storage of telephone call conversations. Connected to the telephone call storage controller 2 are voice recognition starting means 3 and voice recognition stopping means 4. These means may be provided on the mobile terminal device as dedicated switches or buttons, or may be combined into one switch. Alternatively, various buttons or other mechanisms that are already on the mobile terminal device may be used for these means. In the latter case, a button operation for starting or stopping voice recognition is set to be different from an original operation for that button. The telephone call storage controller 2 controls a voice recognition processing unit 5 to start or stop voice recognition based on an input signal from the voice recognition starting means 3 or the voice recognition stopping means 4. The telephone call storage controller 2 stores the result (strings) of a process sequence of voice recognition from the input of a signal to start voice recognition to the input of a signal to stop voice recognition in a predetermined area <1> of memory 6. Then, if a next signal to start voice recognition is input and voice recognition is performed, the telephone call storage controller 2 stores strings resulting from that process sequence from the input of the start signal from the input of a stop signal in another area <2> in the memory 6. The memory 6 may be semiconductor memory, for example. The memory 6 includes a plurality of such areas, each of which has a capacity that can be dynamically changed. Depending on the length of a telephone call, the telephone call storage controller 2 allocates the capacities of the areas used for storage. The telephone call storage controller 2 may have functions of determining whether a telephone call is continued or has been completed and informing an appropriate unit in the terminal of the determination result. According to a user's input operations, a display controller 7 causes strings stored in certain areas of the memory 6 to be displayed on a display unit 8 and controls editing of the strings. Modification and addition to the strings on the display unit 8 are made by inputs through input means such as a dial button. The display controller 7 allows the strings in a plurality of memory areas to be displayed at a time on the display unit 8. The strings are edited as e-mail on the display unit 8 and transmitted by a transmitter 9. The mobile terminal device may have a transmitter or an interface in order to transmit the strings on the display unit 8 to devices such as a personal computer via a cable.

Essentially, the telephone call storage controller 2 takes call packets of a caller and recognizes only the caller's voice. However, the telephone call storage controller 2 may also be adapted to recognize both the caller's voice and the callee's voice. With an appropriate setting or with an input from the means 3 or 4, the telephone call storage controller 2 may automatically start voice recognition upon start of a telephone call, or it may automatically stop voice recognition upon completion of a telephone call. In the case where voice recognition is automatically started upon start of a telephone call, the callee can stop and restart voice recognition with the means 3 or 4 at any points during the telephone call.

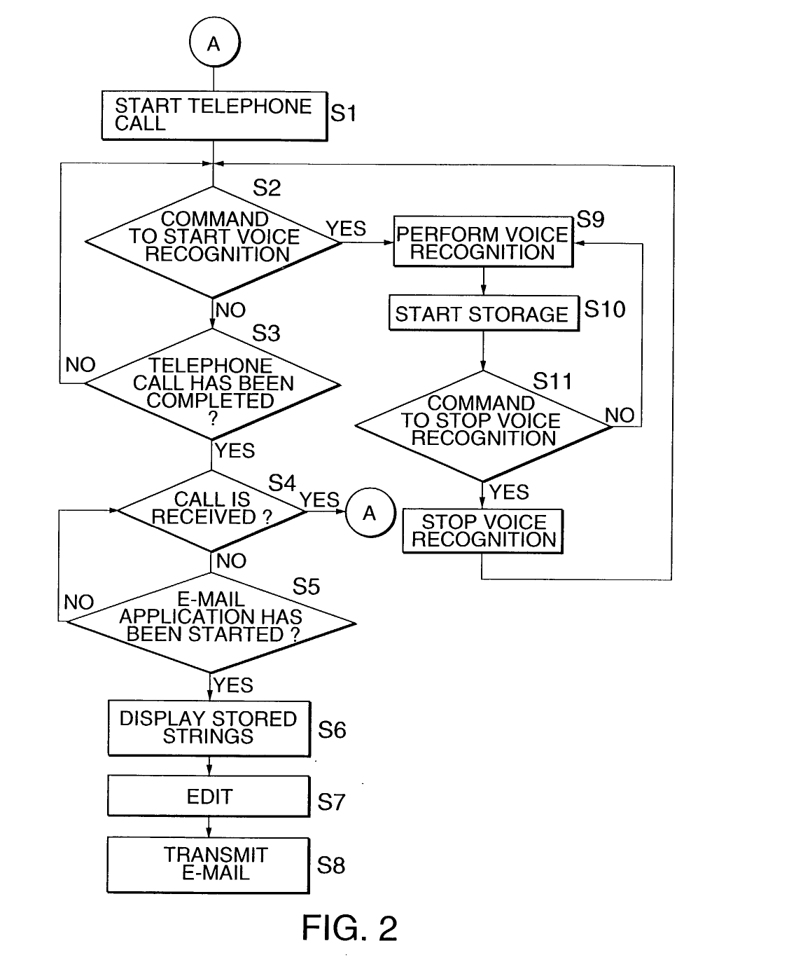

FIG. 2 shows a flowchart of an example of processing in the mobile terminal device from the start of a telephone call to the transmission of e-mail. Once a telephone call is started (S1), it is determined whether a command to start voice recognition has been input (S2). A command to start voice recognition is input through the voice recognition starting means 3 or is provided by the telephone call storage controller 2 with an appropriate setting. When a command to start voice recognition is detected, voice recognition is performed (S9). The telephone call conversation is transformed into strings and stored in a certain area in the memory (S10). This process of voice recognition and storage of strings is continued (NO at S11) until a command to stop voice recognition is input. When a command to stop voice recognition is detected (YES at S11), voice recognition is stopped (S12), and storage of strings is stopped. Then, the flow returns to the step of determining whether a command to start voice recognition has been input. If a command to start voice recognition is not input, it is determined whether the telephone call has been completed (S3). If the telephone call is continued (NO at S3), the flow returns to the step of determining whether a command to start voice recognition has been input. If a command to start voice recognition is detected again, the above operation is repeated. However, this time the strings are stored in another area in the memory.

If the telephone call has been completed (YES at S3), the mobile terminal device makes the transition to a stand-by mode for a call (S4). If a new call is received, a telephone call starts (S1). If a call is not received (NO at S4), it is determined whether an e-mail application has been started (S5). If the e-mail application has been started, the display controller 7 causes the strings in certain memory areas to be displayed on the display unit (S6). The strings are edited on the display unit (S7) and transmitted by e-mail (S8). If the e-mail application has not been started (NO at S5), the mobile terminal device returns to the stand-by mode for a call (S4).

In the above described flowchart, when the device is in the stand-by mode for a call (S4), it is also possible to display the strings and transmit them to other electronic devices via a cable, infrared or Bluetooth means without starting the e-mail application. The transmission may be before or after editing the strings.

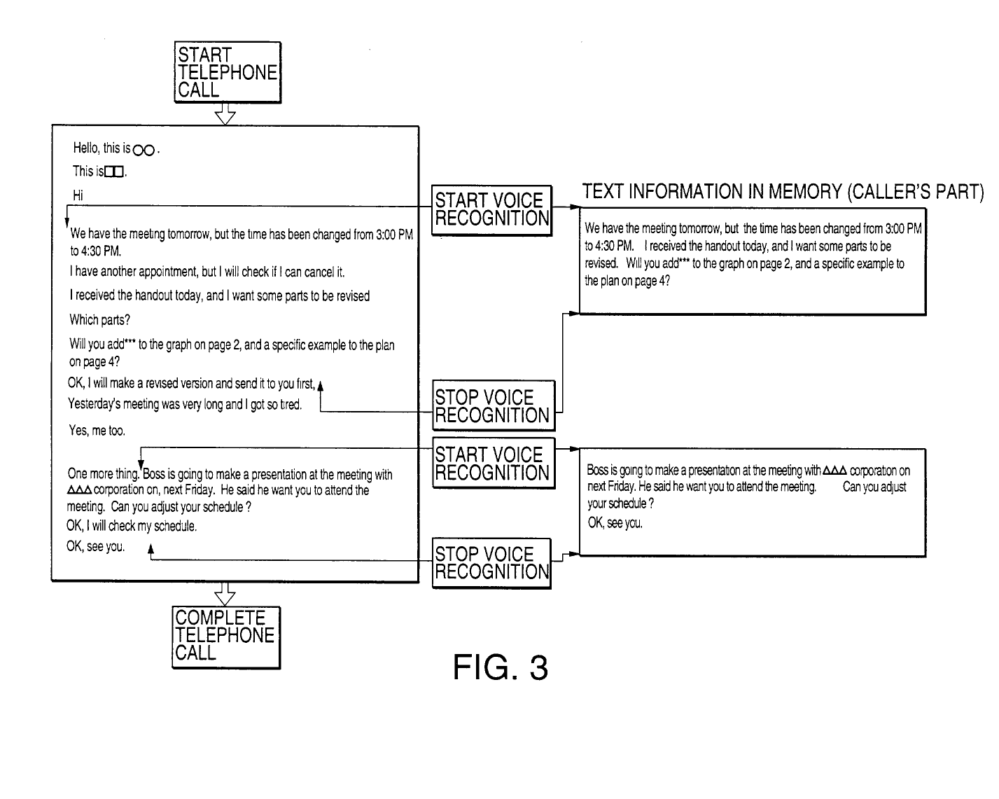

FIG. 3 shows a relation between a telephone call conversation and portions of the conversation stored in the memory. It shows the case where only the caller's part of the conversation (received voice) is transformed into strings and stored. After the telephone call is started and when the callee determines that the conversation needs to be recorded, the callee inputs a command to start voice recognition. Then, voice recognition of the caller's conversation is performed from the point of the input of the command, and the conversation is transformed into strings and stored. When the callee determines that recording is not needed any more, the callee inputs a command to stop voice recognition. Then, the voice recognition operation is stopped. When the telephone call is still continued and if the callee again determines that the conversation needs to be recorded, the callee inputs a command to start voice recognition. Again, the caller's part of the conversation is stored as strings, and the operation is stopped with a command to stop voice recognition, as described above.

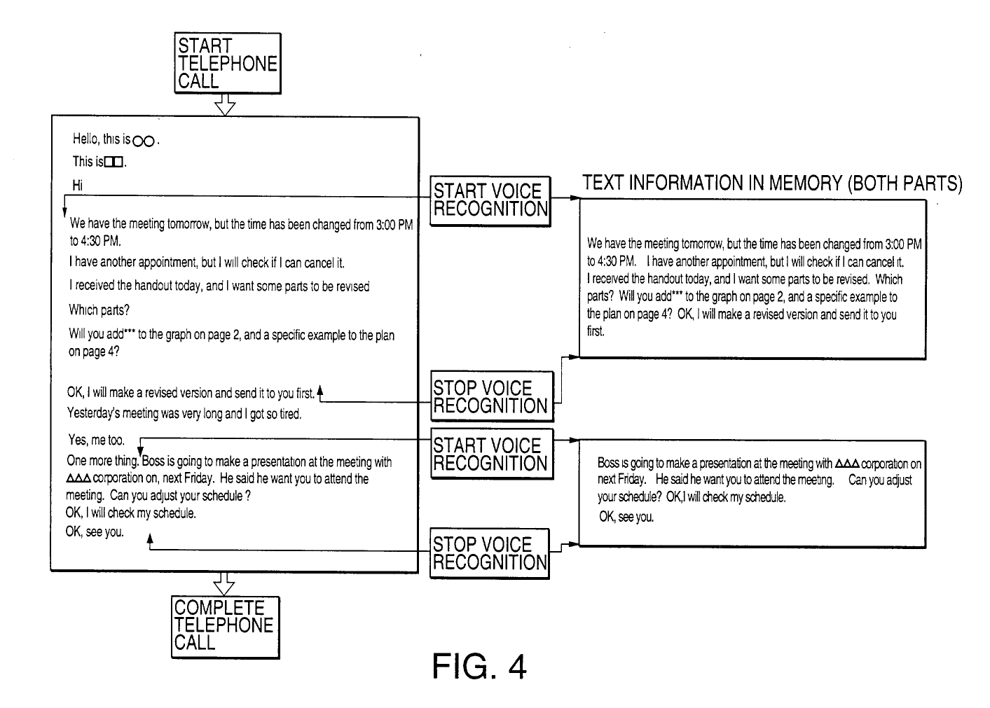

FIG. 4 also shows a relation between a telephone call conversation and portions of the conversation stored in the memory. However, it shows the case where both the callee's part and the caller's part of the conversation are transformed into strings and stored. It is possible to select storing the entire conversation or only the caller's part of the conversation between the input of a command to start voice recognition and the input of a command to stop voice recognition. For this selection, a setting of the telephone call storage controller of the mobile terminal device is changed. The setting can be changed through the voice recognition starting means 3 or the voice recognition stopping means 4 provided on the mobile terminal device.

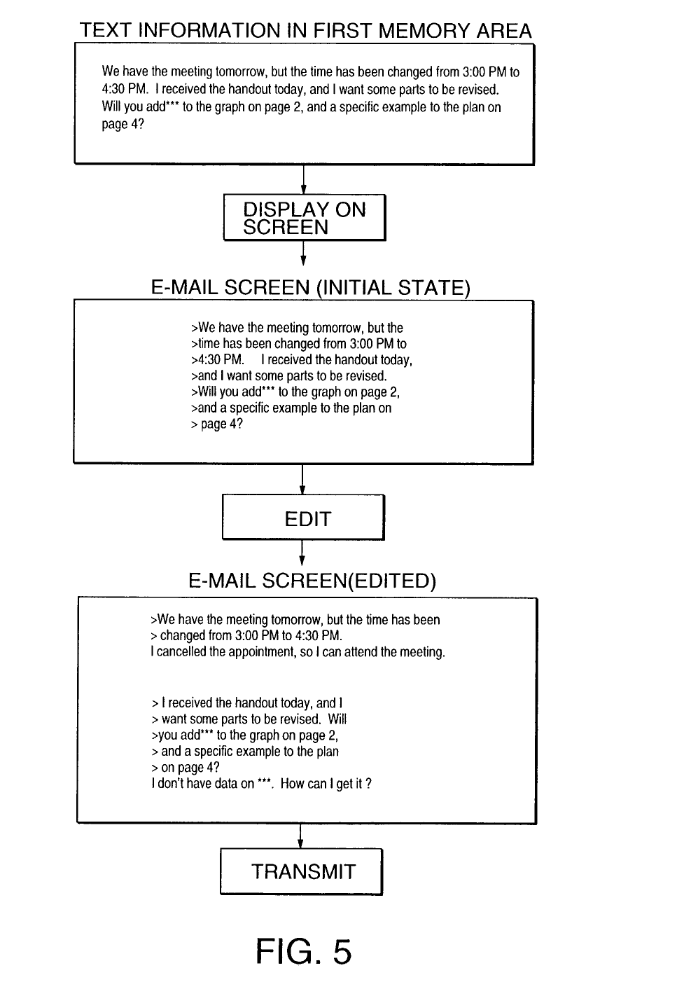

FIG. 5 shows a process of transmitting text information (strings) in the memory by e-mail. When the mobile terminal device is in the stand-by mode, a callee (usually the owner of the mobile terminal device) starts an e-mail application. Then, with predetermined operations, the text information stored in a first area in the memory is displayed on the display unit as a quoted mail message with a symbol “>” at the head of each line (the initial state of an e-mail screen). The callee edits the displayed strings (for example, by deleting unnecessary portions or adding strings) and transmits the strings by e-mail. FIG. 5 shows an example where some strings have been added to the strings in the initial state.

If the mobile terminal device has functions such as a schedule function and a memo function, the strings in the memory may be edited as necessary on the display unit and may be sent to a schedule unit or a memo unit. The strings may also be sent to other electronic devices (for example, a personal computer) via a cable, infrared or Bluetooth means after being edited on the display unit. In these cases, the e-mail application does not need to be started.

The mobile terminal device of the invention also allows for storing a telephone call received from another caller if the memory areas are available. The device also allows for erasing strings stored in the memory and storing a telephone call with a new caller by predetermined operations.

Thus, according to the method and device of the invention, it is possible to perform voice recognition of any portions of a telephone call conversation and record them as strings. This provides efficient use of memory and facilitates editing of the recorded conversation.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A method for recording a telephone call in a mobile terminal device, comprising the steps of:
starting voice recognition of a telephone call conversation during the telephone call;
transforming the conversation subjected to voice recognition into strings and storing the strings in memory of the mobile terminal device;
stopping voice recognition of the conversation during the telephone call.

2. The method for recording according to claim 1, wherein a process from starting to stopping voice recognition is performed for a plurality of times during one telephone call.

3. The method for recording according to claim 2, wherein the strings resulting from each process from starting to stopping voice recognition are stored in a separate area in the memory for each process.

4. The method for recording according to claim 1, wherein voice recognition is performed for only a caller's part of the conversation.

5. The method for recording according to claim 1, wherein voice recognition of the conversation is automatically started upon start of the telephone call.

6. The method for recording according to claim 1, wherein voice recognition of the conversation is automatically stopped upon completion of the telephone call.

7. The method for recording according to claim 1, further comprising the steps of:
displaying the stored strings on a display unit after the telephone call is completed; and
editing the displayed strings on the display unit.

8. The method for recording according to claim 7, further comprising the step of transmitting the edited strings to another electronic device.

9. A method for processing a telephone call by a mobile terminal device that has a voice recognition unit, the method comprising the steps of:
starting voice recognition of a telephone call conversation during the telephone call;
transforming the conversation subjected to voice recognition into strings and storing the strings in memory of the mobile terminal device;
stopping voice recognition of the conversation during the telephone call;
starting an e-mail application after the telephone call is completed;
displaying the stored strings on a display unit;
editing the displayed strings on the display unit; and
transmitting the edited strings by e-mail.

10. The method for processing according to claim 9, wherein a process from starting to stopping voice recognition is performed for a plurality of times during one telephone call.

11. The method for processing according to claim 10, wherein the strings resulting from each process from starting to stopping voice recognition are stored in a separate area in the memory for each process.

12. The method for processing according to claim 9, wherein voice recognition is performed for only a caller's part of the conversation.

13. The method for processing according to claim 9, wherein voice recognition of the conversation is automatically started upon start of the telephone call.

14. The method for processing according to claim 9, wherein voice recognition of the conversation is automatically stopped upon completion of the telephone call.

15. A mobile terminal device comprising:
a telephone call receiver;
a voice recognition processing unit for performing voice recognition of a telephone call conversation and transforming the conversation into strings;
memory for storing the strings;
a telephone call storage controller for controlling voice recognition of the conversation and storage of the strings;
a voice recognition starting means;
a voice recognition stopping means;
a display unit for displaying the strings; and
a display controller for editing the strings on the display unit.

16. The mobile terminal device according to claim 15, comprising a transmitter for transmitting the strings on the display unit.

17. The mobile terminal device according to claim 15, wherein the telephone call storage controller may control the voice recognition processing unit so that voice recognition is performed for only a caller's part of the conversation.

18. The mobile terminal device according to claim 15, wherein the memory includes a plurality of areas for storing the strings.

19. The mobile terminal device according to claim 18, wherein the capacity of each area is variable.

20. The mobile terminal device according to claim 15, wherein the memory is semiconductor memory.

21. The mobile terminal device according to claim 15, wherein the telephone call storage controller may control the voice recognition processing unit so that voice recognition is automatically started upon start of the telephone call.

22. The mobile terminal device according to claim 15, wherein the telephone call storage controller may control the voice recognition processing unit so that voice recognition is automatically stopped upon completion of the telephone call.

23. The mobile terminal device according to claim 15, wherein the voice recognition starting means and the voice recognition starting means are combined into one switch.

24. A mobile terminal device comprising:
a telephone call receiver;
a voice recognition processing unit for performing voice recognition of a telephone call conversation and transforming the conversation into strings;
memory that includes a plurality of areas, each of which having a variable capacity;
a telephone call storage controller for controlling voice recognition of the conversation and storage of the strings;
a voice recognition starting means;
a voice recognition stopping means;
a display unit for displaying the strings;
a display controller for editing the strings on the display unit; and
a transmitter for transmitting the strings on the display unit.
